(19) United States
(12) Patent Application Publication
(10) Pub. No.: US 2024/0158226 A1
(43) Pub. Date: May 16, 2024

(54) GENERATING HYDROGEN AS FUEL FOR ENGINES AND/OR TO PRODUCE ELECTRICITY FOR OILFIELD APPLICATIONS

(71) Applicant: Halliburton Energy Services, Inc., Houston, TX (US)

(72) Inventors: Philip D. NGUYEN, Houston, TX (US); Ronald Glen DUSTERHOFT, Houston, TX (US); Brian Alan EVANS, Houston, TX (US); Stanley Vernon STEPHENSON, Duncan, OK (US)

(21) Appl. No.: 17/987,184

(22) Filed: Nov. 15, 2022

(51) Int. Cl. C01B 3/06

(52) U.S. Cl. CPC C01B 3/061; C01B 2203/02; C01B 2203/066; C01B 2203/1088; C01B 2203/148; C01B 2203/84

(57) ABSTRACT

A system includes a reactor configured for catalytic water splitting to produce hydrogen and byproduct solids via contact of water and aluminum in the presence of a catalyst comprising a metal, a metal hydroxide, a metal oxide, or a combination thereof, wherein the reactor comprises one or more inlets whereby water, aluminum, the catalyst, or a combination thereof are introduced to a reaction chamber of the reactor, an outlet for hydrogen, and an outlet for a slurry comprising water, catalyst, and solids comprising aluminum oxide, aluminum hydroxide, or a combination thereof, a solid/liquid separation apparatus configured to separate the solids from the slurry to provide a solids-reduced slurry, and oilfield equipment. The oilfield equipment is operable via the hydrogen as fuel and/or via electricity produced from the hydrogen.

### CROSS-REFERENCE TO RELATED APPLICATIONS

Not applicable.

### STATEMENT REGARDING FEDERALLY SPONSORED RESEARCH OR DEVELOPMENT

Not applicable.

### TECHNICAL FIELD

The present disclosure relates generally to wellsite operations. More specifically, the present disclosure relates to systems and methods for producing hydrogen for powering oilfield equipment at a wellsite. Still more specifically, the present disclosure relates to systems and methods for powering oilfield equipment at least in part with hydrogen, such as hydrogen produced via catalytic water splitting.

### BACKGROUND

Oilfield operations utilize energy. Conventional combustion of fuels, such as methane and diesel, to meet such energy needs can produce unwanted products, such as carbon dioxide (CO₂) and nitrogen oxides (NOx), which must to be addressed in order to meet ever more restrictive regulations.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic of a system, according to embodiments of this disclosure; and

FIG. 2 is a schematic of another system, according to embodiments of this disclosure.

### DETAILED DESCRIPTION

It should be understood at the outset that although an illustrative implementation of one or more embodiments are provided below, the disclosed systems and/or methods can be implemented using any number of techniques, whether currently known or in existence. The disclosure should in no way be limited to the illustrative implementations, drawings, and techniques below, including the exemplary designs and implementations illustrated and described herein, but can be modified within the scope of the appended claims along with their full scope of equivalents.

Oilfield operations utilize energy. The requisite energy for oilfield equipment is generally derived from a fuel used in an engine or from an electrical distribution line which also requires an energy source, such as a fuel. The combustion of fuels typically produces greenhouse gases (GHGs) which primarily comprise molecules containing carbon (e.g., carbon dioxide (CO₂) and carbon monoxide (CO)). For example, significant amounts of greenhouse gas emissions can be produced into the atmosphere with conventionally powered high horsepower pumping equipment being used in hydraulic fracturing operations. The combustion of hydrogen or the use of hydrogen to produce electricity via fuel cells, however, produces no carbon emissions, since carbon is not a part of the reactions. Accordingly, utilizing hydrogen as a fuel for oilfield equipment or feed to hydrogen fuel cells, as described herein, can be desirable for many reasons, including a potential reduction in the production of GHGs.

Steam Methane Reforming (SMR), methane pyrolysis, and water electrolysis are the most common processes conventionally utilized to generate hydrogen. SMR and methane pyrolysis, which convert methane to hydrogen, require high amounts of energy provide high temperature/pressure to supply high-temperature steam and to maintain the reaction for reducing methane into hydrogen, and SMR results in the production of carbon monoxide (CO) and carbon dioxide (CO₂). Water electrolysis requires electricity, generally produced from renewable energy sources or from a fossil-fuel power plant, to split the water into hydrogen and oxygen. Most of the current energy sources are derived from fossil fuels. Other than depending on electricity generated locally using natural gas powered generators and/or conventional grid supplied electricity, practical means for producing electricity at oilfield sites (also referred to herein as “wellsites”), which can be, for example, located in remote locations, have heretofore been unavailable.

Direct methane fuel cells, in which methane is used directly, without first being converted into hydrogen, typically require temperatures of 750 to 1,000° C. to break strong C—H bonds of methane. Even with the availability of new catalysts, modern methane fuel cells require operating temperatures above 500° C. Disadvantages of methane fuel cells also include system complexity introduced by the requirement for CO₂ recycling, a corrosive molten electrolyte, and relatively expensive cell materials. Accordingly, hydrogen is a preferred fuel for powering fuel cells. However, the cost of producing hydrogen is generally quite high with current hydrogen production methods.

The system and method of this disclosure provide practical means for producing hydrogen for powering oilfield equipment, even in remote locations, whereby the produced hydrogen can be utilized as a fuel source in hydrogen fuel cells for generating electricity to power oilfield equipment and/or to provide hydrogen for use as a fuel (e.g., to engines) for powering oilfield equipment. The system and method described in this disclosure provide a simple solution that does not require high temperature or pressure, electricity, or high cost catalysts to produce the hydrogen. The disclosed system and method for producing hydrogen can be utilized to fuel hydrogen fuel cells and/or can be utilized directly as fuel for oilfield equipment (e.g., to power drilling operations), and can thus be utilized, in embodiments, to reduce conventional (e.g., diesel) fuel usage and/or GIG (e.g., CO₂) emissions.

Via this disclosure, hydrogen can be produced by splitting water via a catalytic reaction and the produced hydrogen captured for use as fuel and/or to produce electricity for powering oilfield equipment. Additionally or alternatively, other apparatus and methods for producing hydrogen can be utilized. A catalytic reaction of aluminum metal particulates in water at ambient temperature in the presence of a catalyst (e.g., a metal, liquid metal, metal hydroxide, and/or metal oxide) acting to facilitate the water splitting (e.g., acting as a catalyst) can be effected in one or more reaction chambers to produce hydrogen gas and byproduct solids comprising aluminum oxide and/or aluminum hydroxide. The produced hydrogen can be fed to hydrogen fuel cells or internal combustion engines to respectively generate electricity or directly power oilfield equipment (e.g., pumping units, such as, without limitation, frac pumps). The reaction chamber can be equipped to handle automation by bridging sensors and control valve systems for (a) monitoring and substantially constant production of hydrogen gas, (b) maintaining a design/desired operating temperature in the reaction chamber, (c) maintaining a substantially constant catalyst concentration, for example by feeding additional aluminum and additional water according to the rates of consumptions of aluminum and water in the reaction chamber, and/or (d) removing the precipitated byproduct aluminum oxide and/or aluminum hydroxide solids (also referred to herein as “aluminum oxide/hydroxide solids”) from the reaction chamber.

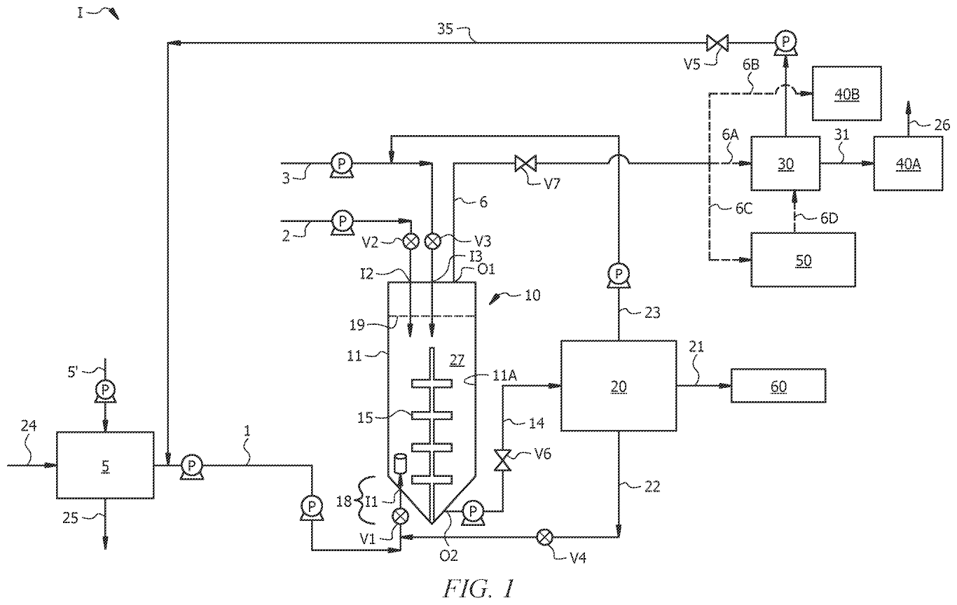

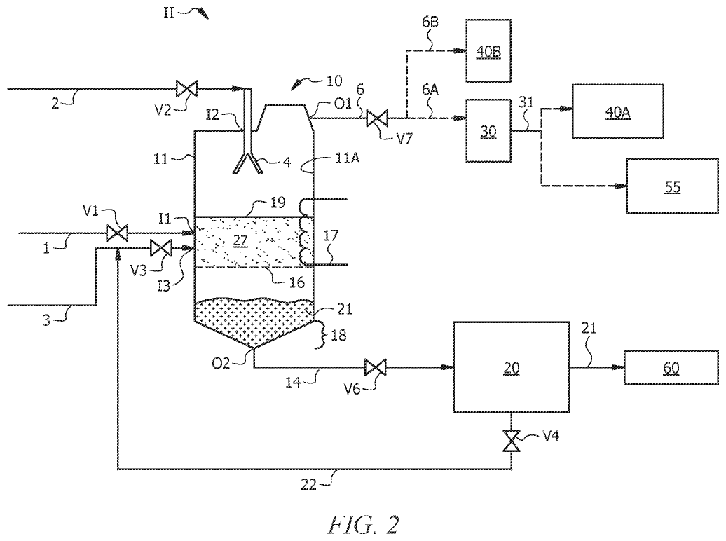

The system and method of this disclosure will now be described with reference to FIG. 1, which is a schematic of a system I, according to embodiments of this disclosure, and FIG. 2, which is a schematic of a system II, according to embodiments of this disclosure. System I/II comprises a reactor 10 configured for catalytic water splitting to produce hydrogen 6 and an aqueous mixture or “slurry” 14 comprising byproduct solids 21 via contact of water 1 and aluminum 2 in the presence of a catalyst 3. The catalyst 3 can comprise a metal, a metal hydroxide, a metal oxide, or a combination thereof. Reactor I/II comprises one or more inlets (I1, I2, I3) whereby water 1, aluminum 2, the catalyst 3, or a combination thereof are introduced to a reaction chamber 11 of the reactor 10. Reactor I/II further comprises an outlet O1 for hydrogen 6, and an outlet O2 for a slurry 14 comprising water 1, catalyst 3, and solids 21 comprising aluminum oxide, aluminum hydroxide, or a combination thereof. The reactor 10 can be configured for water splitting at room temperature, atmospheric pressure, neutral pH, without the use of catalytic electrodes, electric potential, or a combination thereof. The reactor 10 can comprise a stirring/mixing device or “agitator” 15 configured to mix the contents of reaction chamber 11. By way of non-limiting examples, agitator 15 can be selected from sonicators, vibrators, homogenizers, stirrers, blenders, or a combinations thereof.

As noted above, the reactor 10 can be configured for: (a) monitoring and substantially constant production of hydrogen gas 6, (b) maintaining a design temperature in the reactor 10, (c) maintaining a substantially constant catalyst 3 content in reactor 10 by feeding additional aluminum 2 and water 1 according to rates of consumption of aluminum 2 and water 1 in the reaction chamber 11, and/or (d) removing the precipitated byproduct solids 21 (e.g., via slurry 14) from the reaction chamber 11.

An inner wall 11A of the reaction chamber 11 can be designed to prevent or minimize corrosion thereof. The reaction chamber 11 can be equipped with one or more sensors S, such as one or more temperature sensors, chemical sensors, acoustic sensors, optic sensors, or a combination thereof, to provide automation of control valves V1, V2, V3, V4, V5, V6 for maintaining the addition of water 1, aluminum 2, and catalyst 3 to the reactor 10 and removal of byproduct solids 21 via slurry 14 and of hydrogen 6 from the reactor 10. One or more pumps P can be utilized to pump fluids about system I/II. The system I/II can be powered via hydrogen 6, e.g., stored hydrogen 6 in hydrogen storage 50, described further hereinbelow), in embodiments.

Reactor 10 can further comprise a heat exchanger 17 (FIG. 2) configured for the removal of heat produced by the exothermic water splitting reaction from the reaction chamber 11. As may be apparent with the help of this disclosure, the heat from the reaction chamber 11 can be utilized, in embodiments, for other applications. For example, and without limitation, the heat produced in reaction chamber 11 can be utilized for enhancing a hydration rate of a fracturing fluid gel polymer or friction reducer introduced downhole via oilfield equipment 40; can be utilized for enhancing removal of water for drying the separated, byproduct aluminum oxide solids; and or can be utilized for producing pure water 1 from high TDS produced water 5′. In embodiments, the heat exchanger 17 is fluidly connected with a water treatment apparatus 5, described further hereinbelow, such that heat removed from the reaction chamber 11 can be utilized in the water treatment apparatus 5 (e.g., for drying a high-TDS water 5′ to produce a low-TDS water as water 1 for introduction into reactor 10). A processed, low-TDS water 1 can thus, in embodiments, be obtained from produced water of oil or gas wells, and subsequently utilized for hydrogen 6 production as described herein.

The reactor 10 can further comprise a screen 16 positioned below a liquid level 19 in the reaction chamber 10 and configured to allow the aluminum-containing solids 21 to pass therethrough, thus separating the solids 21 from the liquid solution 27 (e.g., catalyst 3 and alumina 2 in water 1) in the reaction chamber 11 and preventing mixing and interference of the produced solids 21 with the catalytic water splitting reaction of the water 1 and the aluminum 2 in the reaction chamber 11.

In embodiments, a bottom portion 18 of the reaction chamber 11 is conical in shape, thus facilitating the accumulation of produced solids 21 in the bottom portion 18 of the reaction chamber 11 and removal thereof from reactor 10 via slurry 14. A dispersing apparatus 4 can be positioned within reaction chamber 11 of reactor 10 for introducing aluminum 2 uniformly therein.

System I/II further comprises a solid/liquid separation apparatus 20 configured to separate the solids 21 from the slurry 14 to provide a solids-reduced slurry 22 comprising water and optionally catalyst. In embodiments described further hereinbelow with reference to FIG. 2, the catalyst 3 comprises a metal hydroxide selected from sodium hydroxide, potassium hydroxide, calcium hydroxide, magnesium hydroxide, or a combination thereof, and/or a metal oxide selected from sodium oxide, potassium oxide, calcium oxide, and combinations thereof, and solids-reduced slurry 22 comprises water 1, and catalyst 3, for example comprising metal hydroxide(s) and/or metal oxide(s). The solids 21 can comprise Al₂O₃, Al(OH)₃, or a combination thereof, in embodiments.

Solid/liquid separation apparatus 20 can be configured to separate catalyst 3 in catalyst stream 23 for example for recycle to the reactor 10. In embodiments discussed further hereinbelow with reference to FIG. 1, the catalyst 3 can comprise a liquid metal, and recycle stream 23 comprises liquid metal catalyst separated in solid/liquid separator 20.

As noted above, system I/II can comprise a recycle line fluidly connecting the solid/liquid separation apparatus 20 with the reactor 10, whereby at least a portion of the solids-reduced solution 22 can be recycled to the reactor 10, and/or a recycle line fluidly connecting the solid/liquid separation apparatus 20 with the reactor 10 for recycle of separated catalyst 3 in recycle stream 23 from the solid/liquid separation apparatus 20 to the reactor 10. A control valve V4 can be operable to control the flow of solids-reduced solution 22 back to reactor 10.

System I/II further comprises oilfield equipment 40. The oilfield equipment 40 is operable via the hydrogen 6 as fuel and/or via electricity produced from the hydrogen 6 (e.g., via combustion of the hydrogen 6 (e.g., in an engine of a generator or “genset”, as described hereinbelow) and/or via conversion of the hydrogen to electricity 31 in one or more fuel cells 30. System I/II can thus further comprise one or a plurality of hydrogen fuel cells 30 operable to produce electricity 31 and byproduct water from at least a portion 6A of the hydrogen 6, and at least a portion of the electricity 31 utilized to power oilfield equipment 40/40A. A water recycle line 35 fluidly connecting the one or the plurality of fuel cells 30 with the reactor 10 can be utilized to introduce water produced via the one or the plurality of the fuel cells 30 into the reactor 10 as a component of water 1. A valve V5 can be operable to provide control of flow of water recycled via water recycle line 35. At least a portion 6B of the hydrogen 6 can be utilized directly as fuel in oilfield equipment 40/40B.

System I/II can further comprise a hydrogen storage apparatus 50 configured to store at least a portion 6C of the hydrogen 6. The hydrogen storage apparatus 50 can be operable to store the at least the portion 6C of the hydrogen 6 as magnesium hydride or via conversion of the hydrogen to electricity and storage of the electricity 31, for example via one or more charged batteries 55. As indicated at 61), the stored hydrogen can, in embodiments, later be utilized a fuel for the oilfield equipment 40 and/or can be introduced into hydrogen fuel cell(s) 30 for the production of electricity 31.

Any sources of aqueous fluids that comprise water can be utilized for hydrogen 6 generation. However, as they undergo catalytic water-splitting in an aqueous composition of catalyst (e.g., liquid metal gallium) and aluminum 2 nanoparticles, high-TDS waters 5′, such as produced water (PW) produced from oil/gas wells, can generate up to 60% less hydrogen when compared to low-TDS or freshwaters. Accordingly, in embodiments, with reference to FIG. 1, water 1 can be a low-total dissolved solids (TDS) water. In embodiments, a system of this disclosure can further include a water treatment apparatus 5 operable to produce a low-TDS water 1 from a high-TDS water 5′, wherein the low-TDS water 1 comprises a lower amount of total dissolved solids than the high-TDS water 5′. The high-TDS water can comprise produced water, in embodiments. In embodiments, the water treatment apparatus 5 can comprise apparatus configured for contacting the high-TDS water 5′ with carbon dioxide (CO₂) 24 to produce a precipitant 25 comprising one or more metal carbonates from the low-TDS water 1. Alternatively or additionally, the water treatment apparatus 5 can be configured for heating the high-TDS water 5′ to produce the low-TDS water 1 via evaporation and/or distillation. In embodiments, CO₂ is produced by the oilfield apparatus 40 and/or is produced at a same location as that of the oilfield apparatus 40. In this manner, CO₂ can be sequestered by production of the precipitant 25, and low-TDS water 1 can be concomitantly produced for utilization in the catalytic water splitting reaction in reactor 10. The CO₂ 24 can be sequestered via the production of precipitant 25 comprising metal carbonates, for example substantially as described in U.S. patent application Ser. No. 17/537,640, filed Nov. 30, 2021 and entitled. “Carbon Dioxide Sequestration”, and/or U.S. patent application Ser. No. 17/407,381, filed Aug. 20, 2021 and entitled, “Method of Providing Clean Air, Clean Water, and/or Hydraulic Cement at Well Sites”, the disclosure of each of which is hereby incorporated herein in its entirety for purposes not contrary to this disclosure.

The CO₂ 24 can be a component of an exhaust gas 26, such as an exhaust gas 26 produced by fracturing operations on-site at a same location as the oilfield equipment 40 and/or the reactor 10, can be a component of an exhaust gas 26 produced via a power plant, can be a component of an exhaust gas 26 produced from a cement plant, or a combination thereof.

The high-TDS water 5′ (e.g., produced water) can be produced on-site at a same location as the oilfield equipment 40 and/or the reactor 10, or elsewhere.

The aluminum 2 can comprise aluminum particulates. By way of non-limiting example, the aluminum particulates can comprise flakes, sawdust, milling shavings, chips, powder, or a combination thereof. The aluminum 2 particulates can have a large surface to volume ratio. In embodiments, the aluminum 2 comprises new or pristine aluminum foil or a recycled aluminum, such as selected from aluminum foil, food wrapping, beverage cans, baking trays (e.g., commercial baking trays), machine shop waste (e.g., aluminum chips, shavings, and/or sawdust), fireworks, aluminum powder, or a combination thereof.

In embodiments, as noted hereinabove, the catalyst 3 comprises a metal oxide and/or metal hydroxide. In such embodiments, the solids-reduced slurry 22 can comprise an aqueous metal hydroxide and/or metal oxide solution. In embodiments, catalyst 3 comprises a liquid metal. In embodiments, the catalyst 3 can comprise gallium, indium, tin, or a combination thereof. The liquid metal 3 can have a melting point in a range of from about 20 to about 40° C., from about 25 to about 40° C., or from about 25 to about 35° C. 20. In embodiments, the catalyst 3 comprises a liquid metal selected from gallium, indium, tin, or a combination thereof. Solids 21 can comprise aluminum oxide (Al₂O₃).

The oilfield equipment 40 can comprise any equipment utilized at a wellsite that can be operated via combustion of hydrogen 6 as fuel or via electricity 31 produced in one or more hydrogen fuel cells 30 utilizing the hydrogen 6. In embodiments, oilfield equipment 40 comprises hydraulic fracturing equipment, such as, for example, one or more frac pumps. For example, with reference to FIG. 2, system I/II can include oilfield equipment 40A that can be fueled by a fuel comprising at least a portion 6B of hydrogen 6, and/or can include oilfield equipment 40B can be powered by electricity 31 produced via at least a portion 6A of the hydrogen 6, for example via combustion of the at least the portion 6A of the hydrogen 6 or via conversion of the at least the portion 6A of the hydrogen 6 to electricity 31 in one or more fuel cells 30.

Components of the hydrogen generation of system I/II (e.g., reactor 10, separation apparatus 20, and/or water treatment apparatus 5) can be located at a central location and the oilfield apparatus 40 can be located at the central location or another location. Thus, the hydrogen can be produced at a central location and the oilfield apparatus 40 operated at the central location or another location. In embodiments, the system I/II is positioned on a trailer or skid configured for positioning at a location at which the oilfield equipment 40 is located. Positioning of the system I/II at the central location can be desirable to minimize logistic issues of shipping/transporting materials (e.g., reactors 10, aluminum 2, water 1, high-TDS water (e.g., PW) 5′, catalyst 3, solids 21) to and from the individual locations or well sites.

A method of this disclosure can comprise: producing hydrogen 6 and a slurry 14 comprising water 1, unreacted catalyst 3, and byproduct solids 21 by catalytic water splitting via contact of water 1 and aluminum 2 in the presence of a catalyst 3 comprising a metal, a metal hydroxide, a metal oxide, or a combination thereof; separating the solids 21 from the slurry 14 to provide a solids-reduced slurry 22; and operating oilfield equipment 40 via the produced hydrogen 6 as fuel and/or via electricity 31 produced from the hydrogen 6.

The method can further comprise recycling at least a portion of the solids-reduced solution 22 to the reactor 10. In embodiments, catalyst in a catalyst recycle stream 23 comprising catalyst 3 is also separated from the slurry 21. The separated catalyst 3 in catalyst recycle stream 23 can be recycled to the reactor 10 for further water splitting.

As noted hereinabove, in embodiments, water 1 comprises a low-total dissolved solids (TDS) water. The method can further comprise producing the low-TDS water 1 from a high-TDS water 5′, wherein the low-TDS water 1 comprises a lower amount of total dissolved solids than the high-TDS water 5′. In embodiments, water 1 (e.g., the low-TDS water 1) comprises less than or equal to about 0, 100, 500, or 2000 ppm (parts per million) TDS, and the high-TDS water comprises greater than or equal to about 2500, 5000, 25000, or 300000 ppm TDS. The dissolved solids can include, for example, salts of monovalent and/or divalent cations, such as sodium, magnesium, calcium, etc. In embodiments, the high-TDS water 5′ comprises produced water (PW). Producing the low-TDS water 1 can comprise contacting the high-TDS water 5′ with carbon dioxide (CO₂) 24 to produce a precipitant 25 comprising one or more metal carbonates and separating the precipitant 25 from the low-TDS water 1; and/or heating the high-TDS water 5′ to produce the low-TDS water 1, for example, via evaporation and/or distillation of low-TDS water 1 from high-TDS water 5′. In embodiments, high-TDS water 5′ produced from oil/gas wells is processed in water treatment apparatus 5 to provide a source of low-TDS or freshwater 1 for use in catalytic reaction with a catalyst 3 (e.g., a liquid metal alloy of aluminum-gallium) to generate hydrogen 6 as a fuel for oilfield equipment 40 and/or 112-fuel cells 30 for powering oilfield (e.g., hydraulic fracturing) equipment, or for H₂ storage in hydrogen storage apparatus 50 as a source of fuel on demand.

The CO₂ 24 can be from any source. In embodiments, the CO₂ 24 is produced by the oilfield apparatus 40 and/or is produced at a same location as that of the oilfield apparatus 40 and/or the reactor 10. The method can further comprise producing the produced water. The PW can be produced on-site at a same location as the oilfield equipment 40 and/or the reactor 10, or elsewhere. For example, the CO₂ 24 can be a component of an exhaust gas 26 produced by hydraulic fracturing operations on-site at a same location as the oilfield equipment 40 and/or the reactor 10 or another location, the CO₂ 24 can be a component of an exhaust gas 26 produced via a power plant, the CO₂ 24 can be a component of an exhaust gas 26 produced from a cement plant, an exhaust gas 26 produced via another process, or a combination thereof.

Accordingly, in embodiments, the herein disclosed systems and methods enable processing of high-TDS water 5′, such as water that has been produced from oil/gas wells, to produce low-TDS or freshwater 1, and using this processed water 1 in generating hydrogen 6 as a fuel source for powering oilfield equipment 40, such as, without limitation, that involved in hydraulic fracturing operations.

The high-TDS produced water 5′ can be “desalinated” by reacting the divalent cations (e.g., Ca²⁺, Mg²⁺) existing in the produced, high-TDS water 5′ with CO₂24 obtained from captured exhaust gas 26 of oil field equipment 40 at the wellsite (or can be brought (e.g., trucked) in from another source/location) to form a concentrated slurry of solid precipitant 25 (e.g., of magnesium carbonate (CaCO₃) and/or magnesium carbonate (MgCO₃)). By separating the concentrated solids precipitant 25 from the carbonate slurry, the high-TDS water 5′ can be transformed into low-TDS or freshwater 1. This processed water 1 can then be utilized in the catalytic water splitting reaction (e.g., with a liquid metal alloy composition wherein the liquid metal alloy comprises aluminum nanoparticles 2 dispersed in a liquid metal (e.g., gallium)), such that water 1 is split at ambient or low temperatures to produce hydrogen gas 6 and byproduct aluminum oxide solids 21, as expressed in Equation 1 below.

With reference to FIG. 1, in embodiments, hydrogen 6 is generated from water 1 (which can be a processed low-TDS water 1 produced from a high-TDS water 5′ in water treatment apparatus 5) via a catalytic reaction between water 1 and a catalyst 3 comprising a liquid metal or liquid metal alloy composition. The catalyst 3 can comprise, for example, a liquid metal selected from gallium, indium, tin, or a combination thereof. The method can comprise providing a source of (e.g., low-TDS) water 1; providing a source of aluminum 2 particulates; providing a catalyst 3 comprising low melting-point metals, such as, without limitation, gallium, indium, tin, etc. The low melting-point metals can be mixed and melted in one or more reaction chambers 11 at temperatures (e.g., from 30 to 50° C.) to form a liquid metal alloy. Aluminum 2 particulates can be added to the liquid metal alloy catalyst 3 while maintaining temperatures above the melting point, e.g., 30 to 50° C. Agitation energy can be applied to the content 27 of the reaction chamber 11 to dissolve aluminum particulates 2 into nanoparticles and disperse aluminum nanoparticles 2 in the matrix of liquid metal alloy 3 (e.g., aluminum 2 nanoparticles in gallium liquid metal catalyst 3 droplets). An amount of water 1 can be introduced into the reaction chamber 11 containing the liquid metal alloy catalyst 3. Agitation energy can be applied to the content 27 (e.g., aluminum 2 gallium catalyst 3 liquid droplets in water 1) of reaction chamber 11 to disperse and transform the liquid metal catalyst 3 into fine sized droplets, forming a dispersion of liquid metal droplets in aqueous solution. The aluminum nanoparticles can have a size in a range of from about 1 to about 25 nm, from about 1 to about 100 nm, from about 1 to about 1000 nm, from about 25 to about 100 nm, or from about 100 to about 950 nm, in embodiments. In embodiments, as depicted in FIG. 1, the aluminum 2 and catalyst 3 (e.g., liquid metal catalyst such as gallium, indium, tin) can be introduced at or near a top (e.g., a top third, a top quarter) of reaction chamber 11, and water 1 can be introduced into a lower portion (e.g., a lower third, a lower quarter) of reaction chamber 11.

The method can comprise allowing the contact and interaction between the water 1 and the aluminum nanoparticles 2 in the liquid metal droplets of the catalyst 3 while maintaining agitation energy (e.g., via agitator 15), thereby enhancing water splitting to produce hydrogen 6 and solids 21 of aluminum oxide solids 21 as a byproduct. The hydrogen gas 6 can exit from a top side of reaction chamber 11 to be collected for storage in storage apparatus 50 and/or to feed directly into oilfield equipment 40 as fuel (e.g., into a motor of a generator or other oilfield equipment 40), and/or into one or a plurality of hydrogen fuel cells 30 for generating electricity 31 to power oilfield (e.g., fracturing) equipment 40.

Solid/liquid separation apparatus 20 can be utilized for filtering the liquid metal alloy that has been laden with aluminum oxide solids 21 to remove the aluminum oxide solids 21 from the liquid metal dispersion or “slurry” 14, thereby allowing the liquid metal catalyst 3 in catalyst recycle stream 23 to be recycled to reaction chamber 11 for contact with additional aluminum 2 and water 1.

Alternately, a liquid metal alloy (e.g., comprising aluminum 2 and metal catalyst 3 (e.g., gallium)) and a warm aqueous fluid 1 can be mixed separately in a container to allow the liquid metal catalyst 3 to be dispersed to form a dispersion comprising fine droplets of liquid metal. This dispersion can then be introduced into the reaction chamber 11. Thus, although disparate inlets I1, I2, and I3 are depicted in the embodiments of FIG. 1 (and FIG. 2 described further hereinbelow), one or more components selected from the water 1, the aluminum 2, and the catalyst 3 can be combined prior to or concomitantly during introduction into reaction chamber 11 of reactor 10.

The mass ratio of catalyst 3 (e.g., metal, such as gallium, metal hydroxide/oxide) to aluminum 2 can range from about 5:1 to about 13:1, from about 6:1 to about 12:1, or from about 7:1 to about 10:1.

Hydrogen 6 generation can occur at the interface between aluminum 2 and water 1, thus requiring a pristine aluminum 2 surface with high surface area. Aluminum 2 does not generate hydrogen gas 6 because a passivating oxide layer typically prevents any reaction from occurring with water 1. The catalyst (e.g., liquid metal gallium) can be used to dissolve aluminum 2, thus removing any passivating aluminum oxide film to form aluminum 2 nanoparticles dispersed within the matrix of the catalyst 3 metal (e.g., gallium), and preventing the aluminum particulates 2 from agglomerating. Thus, the method of this disclosure can provide nano-size and pristine surface aluminum nanoparticles 2 enabling aluminum 2 to split water 1 to produce hydrogen gas 6 and byproduct aluminum oxide solids 21. For example, molten aluminum 2-metal catalyst 3 alloys (e.g., aluminum-gallium alloys) have low melting points, and do not possess a coherent and adherent oxide layer.

After using the liquid metal alloy (e.g., gallium-aluminum), the catalyst 3 (e.g., gallium) can be recovered and recycled to make additional gallium-aluminum liquid metal for further water splitting in reaction chamber 11. The recovery of the catalyst (e.g., gallium) can be accomplished from the alloy after the water splitting reaction by filtration and an aqueous rinse, in separation apparatus 20.

As described further hereinbelow, water produced from 112-fuel cell(s) 30 as a byproduct of electricity 31 generation can be combined (e.g., via water recycle line 35) with water 1 (e.g., from water treatment apparatus 5) for use in water-splitting in reactor 10 to produce hydrogen 6.

In embodiments, a catalytic liquid alloy composition can be formed by mixing liquid metal catalyst 3 (e.g., gallium) at temperature between 25 to 30° C. with solid particulates of aluminum 2, wherein the mixing dissolves the aluminum 2 particulates into nanoparticles, and disperses the nanoparticles within the matrix of the metal catalyst 3 (e.g., gallium). Once the water 1 (e.g., processed, low-TDS water 1) is exposed to this liquid metal alloy composition, water 1 undergoes catalytic reaction with aluminum 2 nanoparticles, splitting its structure to generate hydrogen gas 6 and solids 21 comprising aluminum oxide. In alternative embodiments, a liquid, catalytic alloy composition is first formed by mixing a liquid metal catalyst 3 (e.g., gallium) (e.g., at temperature between 25 to 30° C.) with solid particulates of aluminum 2, wherein the mixing dissolves the aluminum 2 particulates into nanoparticles, and disperses the aluminum 2 nanoparticles within the matrix of the metal catalyst 3 (e.g., gallium). This liquid catalytic composition is then exposed to low temperature below 5° C. to transform the composition into a solid mass of alloy. The solid mass of alloy can be grinded, chopped, or extruded to form pellets, nuggets, or particulates of desirable sizes and/or weights. When needed, this solid catalytic composition can be heated (e.g., to 25 to 30° C.), or exposed to warm water (e.g., greater than or equal to about 30° C.), in a reaction chamber 11 to undergo catalytic reaction to produce hydrogen 6 and aluminum oxide solids 21. The use of liquid metal catalysts 3 and alloys thereof with alumina 2 (to provide a “metal alloy catalyst” 3 that can be heated to provide a liquid alloy metal catalyst 3 comprising liquid metal and aluminum 2) can allow for hydrogen 6 production on demand to avoid storage and transportation of hydrogen gas 6, which requires liquefaction of hydrogen gas 6. This method of forming the liquid metal catalyst 3 can also be utilized without using heat and other energy extensive procedures.

Any form of mechanical agitation can be applied to the content 27 in the reaction chamber 11 to disperse the liquid metal catalyst 3 into fine droplets suspending in an aqueous solution 27. Examples of mechanical agitation provided by agitator 15 include, but are not limited to, sonication, vibration, homogenizer, rapid stirring, blending, or mixing. The mechanical agitation can be continuously applied to the content 27 in the reaction chamber 11 during the reaction time to keep the liquid metal droplets of catalyst 3 in the dispersion and to enhance the contact and reaction of aluminum 2 nanoparticles with water 1 to generate hydrogen 6.

In embodiments, a water-splitting catalytic composite that can be used in generating hydrogen 6 from water 1 on demand via a catalytic reaction between water 1 and the catalytic composite comprises: providing a source of water 1 (e.g., low-TDS water 1); providing a source of aluminum 2 particulates; providing a source of low melting-point metals, such as gallium, indium, tin, etc., or a combination thereof; providing a source of a liquid alkane; mixing and melting the low melting-point metals in one or more reaction chambers 11 at temperatures from 30 to 50° C. to form a liquid metal alloy; adding aluminum 2 particulates to the liquid metal alloy while maintaining temperatures above the melting point, e.g., from about 20 to about 40° C., from about 25 to about 40° C., from about 30 to about 50° C., or from about 25 to about 35° C.; applying an agitation energy to the content 27 of the reaction chamber 11 to dissolve aluminum 2 particulates into nanoparticles and disperse aluminum 2 nanoparticles in the matrix 27 of liquid metal alloy; cooling down the content 27 of the reaction chamber 11 (e.g., to a temperature of less than 20, 15, 10, or 5° C., to transform the liquid metal containing aluminum 2 nanoparticles into a semi-solid mass of metal alloy; allowing the semi-solid metal alloy to be extruded, chopped, sheared, or grinded into solid masses of catalytic metal alloy with desirable sizes, weights, and shapes; submerging the catalytic metal solids in an alkane solution (or storing the metal alloy solids in a container filled with argon) to minimize exposure of the metal alloy solids to oxygen in the atmosphere during storage at room temperature; allowing the prepared catalytic metal alloy solids to react with water 1 (e.g., treated low-TDS water 1) on demand to produce hydrogen 6.

In embodiments, the water-splitting catalytic metal alloy solids can be heated in a reaction chamber 11 to a temperature above the melting point, e.g., above about 30° C., to transform the catalytic metal alloy solids into a liquid metal alloy. Warm water 1 can be introduced into the reaction chamber 11 containing the liquid metal alloy while applying an agitation energy to the content 27 of reaction chamber 11 to disperse and transform the liquid metal into small-sized droplets, forming a dispersion of liquid metal droplets in aqueous solution 27. The contact and reaction between the water 1 and the aluminum 2 nanoparticles can be greatly enhanced, thereby allowing the water 1 to split to produce hydrogen gas 6 and solids 21 of aluminum oxide as a byproduct. The generated hydrogen 6 can exit the reaction chamber 11 to be collected for storage in hydrogen storage apparatus 50 and/or for feeding directly into oilfield (e.g., hydraulic fracturing) equipment 40 and/or for feeding directly into a hydrogen fuel cell(s) 30 for generating electricity 31 to power the oilfield (e.g., hydraulic fracturing) equipment 40. After a reaction period, the liquid metal alloy that has been laden with aluminum oxide solids 21 can be filtered and separated (e.g., in solid/liquid separation apparatus 20) to remove the aluminum oxide solids 21 from the liquid metal, thereby allowing the liquid metal to be recycled (e.g., via catalyst recycle stream 23) and replenished with new aluminum 2 particulates to again form a water-splitting catalytic composition.

In embodiments, the catalyst 3 comprises metal oxide and/or metal hydroxide. In such embodiments, the solids-reduced slurry 22 can comprise an aqueous metal hydroxide and/or metal oxide solution and the solids 21 can comprise aluminum oxide (Al₂O₃).

Equations (1) and Equation (2) show exemplary catalytic reactions of aluminum in water in the presence of catalyst 3 (e.g., comprising metal hydroxide/oxide or liquid metal):

2Al+3H₂O→Al₂O₃+3H₂ (Eq. 1)

2Al+6H₂O→2Al(OH)₃+3H₂ (Eq. 2).

With reference to FIG. 2, in embodiments, a method of producing hydrogen 6 for generating hydrogen 6 for use as fuel and/or for producing electricity 31 to power oilfield equipment 40 (and reducing greenhouse gas emissions) comprises: providing a source of water 1 (e.g., low-TDS or freshwater); a source of aluminum 2 particulates; a source of catalyst 3 comprising metal hydroxide and/or metal oxide (solids or concentrated liquid); providing one or more reaction chambers 11; introducing an aqueous-based solution containing the catalyst 3 (e.g., metal hydroxide and/or metal oxide and water 1) into a reaction chamber 11 (e.g., via opening valve V3 (e.g., at a low position) of reaction chamber 11); introducing aluminum 2 particulates into the reaction chamber 11 (e.g., via a controlled inlet valve V2 (e.g., from a top of the reaction chamber 11)); allowing the aluminum 2 particulates to interact with the aqueous solution as they settle (or land) on wire-mesh screen 16 positioned a distance from the solution surface or liquid level 19; allowing the catalytic water splitting reaction to occur between aluminum 2 particulates and water 1 in the presence of the metal hydroxide/oxide catalyst 3 to produce hydrogen gas 6 and byproduct aluminum oxide solids 21; collecting the hydrogen gas 6 being produced (e.g., via a controlled outlet valve V7 positioned at a top of the reaction chamber 11); allowing aluminum oxide solids 21 to precipitate through the wire-mesh screen 16 and accumulate at a bottom (e.g., conical section 18) of the reaction chamber 11; and removing the accumulated aluminum oxide solids 21 via slurry 14 and transferring to a water-aluminum oxide solid/liquid separation apparatus 20.

Depending on the desired hydrogen 6 production rate and optimal temperature in reaction chamber 11, additional water 1 and aluminum 2 particulates can be introduced into the reaction chamber 11 via respective controlled inlet valves V1/V3 and V2, respectively, to maintain the catalytic reaction for substantially continuous and/or constant production of hydrogen gas 6 Each reaction chamber 11 can be equipped to handle automation by bridging sensors S and control valve systems to allow: (a) monitoring and substantially constant production of hydrogen gas 6; (b) maintaining a designed temperature in the reaction chamber 11; (c) maintaining a substantially constant metal hydroxide/oxide catalyst 3 concentration within the reaction chamber 11 by feeding additional aluminum 2 and/or additional water 1 according to the rates of consumptions of aluminum 2 and water 1 in the reaction chamber 11, and (d) removing the precipitated byproduct aluminum oxide solids 21 from the reaction chamber 11 (e.g., via removal of slurry 14 from reaction chamber 11).

In embodiments, catalyst 3 comprises metal hydroxides such as, but not limited to, sodium hydroxide, potassium hydroxide, calcium hydroxide, magnesium hydroxide, or a combination thereof. Alternatively or additionally, catalyst 3 can comprise metal oxides including, but not limited to, sodium oxide, potassium oxide, calcium oxide, and magnesium oxide, or a combination thereof.

In embodiments, the aluminum 2 particulates are prepared as a slurry prior to introducing into the reaction chamber 11, wherein the aluminum slurry comprises an aqueous (e.g., freshwater), or a non-aqueous (e.g., ethylene glycol) liquid, and a known concentration of aluminum 2 particulates. In embodiments, as noted above, the aluminum 2 particulates are in the forms of flakes, sawdust, milling shavings, chips, powder, or other similar small particulates having a large surface to volume ratio.

In embodiments, catalyst (e.g., metal hydroxide and/or oxide catalyst 3) is dissolved in an aqueous-based fluid comprising water 1 prior to introduction into the reaction chamber 11. In embodiments, catalyst (e.g., metal hydroxide and/or oxide catalyst 3) is introduced into the reaction chamber 11 as dry particulates in a known amount, wherein the reaction chamber 11 contains a known volume of water 1.

In embodiments, a source of catalyst (e.g., metal hydroxide and/or oxide catalyst 3) is prepared as a slurry prior to introduction into the reaction chamber 11. The catalyst 3 (e.g., metal hydroxide) slurry can comprise an aqueous (e.g., freshwater 1), or a non-aqueous (e.g., ethylene glycol) liquid, and a known concentration of catalyst 3 (e.g., metal hydroxide and/or oxide catalyst 3).

The produced hydrogen 6 can be stored. For example, a portion 6C of the hydrogen 6 can be stored in hydrogen storage apparatus 50. In embodiments, the hydrogen can be stored in a dispersion of fine magnesium particulates in light mineral oil in the form of magnesium hydride at atmospheric pressure and room temperature. On demand, hydrogen can be released from magnesium hydride via heating of the dispersion, whereby the magnesium hydride is converted to magnesium that can be recharged with hydrogen (e.g., under pressure), perhaps yielding increased hydrogen.

In embodiments, the produced hydrogen gas 6 is a fuel source for hydrogen fuel cells 30 or internal combustion engines of oilfield equipment 40, to produce electricity or to directly power apparatus (e.g., frac pumps). The produced electricity 31 can be used to directly power the oilfield equipment 40 or to charge batteries 55. Accordingly, in embodiments, the hydrogen 6, or a portion 6A thereof, can be utilized in hydrogen fuel cell(s) 30 to produce electricity 31, a portion or all of which can be utilized to charge batteries, thus providing charged batteries 55, thus effectively storing the energy of the hydrogen 6A for later use.

As noted above, the inner wall 11A of the reaction chamber 11 can be lined/coated/plated with a non-metal liner/coating to minimize or prevent corrosion. The reaction chamber 11 can be equipped with sensor S, such as and without limitation, temperature sensors, chemical sensors, acoustic sensors, optic sensors, or combination thereof, to provide automation of control valves (e.g., valves V1, V2, V3, V4, V5, V6, and/or V7) for maintaining the addition of water 1, aluminum particulates 2, catalyst 3, recycle water in solids-reduced slurry 22, catalyst 3 in recycle catalyst stream 23, and/or in water recycle stream 35, and the removal of byproduct precipitated solids 21 via slurry 14 and outlet O2 and hydrogen gas 6 via outlet O1.

For example, reaction chamber 11 can comprise a control valve V2 for operating an additive feeder to add aluminum 2 particulates from the top of the reaction chamber 11; a control valve V1 for supplying water 1 into the reaction chamber 11 from a lower part of reaction chamber 11; a control valve V3 for supplying metal oxide or metal hydroxide catalyst 3 into the reaction chamber 11 from a lower part of the reaction chamber 11; a (e.g., coiled) heat exchanger 17 lining the inner wall 11A of the reaction chamber 11 to regulate the water splitting reaction temperature within reaction chamber 11; a wired mesh screen 16 stationed a distance below the fluid surface 19 in the reaction chamber 11 to allow the produced aluminum oxide solids 21 to precipitate through the screen openings 16, thereby separating and preventing them from mixing and interfering with the reaction of aluminum particulates 2 in water 1; and/or a conical shape bottom section 18 to help accumulate produced (e.g., aluminum oxide) solids 21.

In embodiments, the heat produced via the exothermic water splitting reaction within reaction chamber 11 can be utilized for drying/dehydrating the wet solids 21 (e.g., the wet aluminum oxide particulates) obtained from the liquid-solids separator 20 to turn them into dry solids and producing pure/fresh water. The water obtained by the drying of the wet solids 21 can be utilized elsewhere, for example, can be recycled to reaction chamber 11 for further water splitting. Alternatively or additionally, the heat produced from reaction chamber 11 can be utilized to treat high-TDS water 5′ in water treatment apparatus 5 to produce low-TDS water 1 (e.g., substantially pure or fresh water 1) via evaporation/distillation.

As noted hereinabove, all or a first portion 6A of the hydrogen 6 can be introduced into one or a plurality if fuel cells 30 for the production of electricity 31 and byproduct water. At least a portion of the byproduct water produced from the hydrogen fuel cells 30 can be recycled via water recycle stream 35 into the reactor 10 for further water splitting. The electricity 31 can be utilized to power oilfield equipment 40/40A, and/or can be stored, for example in one or more batteries 55 and/or hydrogen storage apparatus 50. All or a second portion 6B of the hydrogen 6 produced in reactor 10 can be introduced directly into oilfield equipment 40/40B as a fuel. All or a third portion 6C of the hydrogen 6 produced in reactor 10 can be stored directly in hydrogen storage apparatus 50, as described hereinabove. As desired, all or a portion 6D of the hydrogen 6C stored in hydrogen storage apparatus 50 can be utilized, for example as feed to the fuel cell(s) 30. Storing the hydrogen 6 can comprise storing the at least the portion of the hydrogen as magnesium hydride or converting the hydrogen 6 to electricity 31 and storing the electricity 31 via one or more charged batteries 55.

Aluminum oxide solids 21 have multiple commercial usages and applications, and thus the solids 21 can be utilized to advantage, in embodiments. For example, in embodiments, solids 21 comprise aluminum oxide, which finds use in several disparate industries or apparatus 60 for use of the separated byproduct solids 21, a few of which will be noted herein. For example, aluminum oxide solids 21 can be utilized in oil/gas well completions (as a component of well cement compositions, a propping agent used in hydraulic fracturing treatments as proppant or micro-proppant); in industrial applications (e.g., as a filler for bricks, plastics, and heavy clayware, abrasive component of sandpaper, or as a replacement for industrial diamonds); in the electrical industry (e.g., as high temperature furnace insulation, electrical insulators, etc.); in the medical industry (e.g., to produce bionic implants, tissue reinforcement, prostheses, hip replacement bearings, etc.); in the production of protective equipment (e.g., for enhancing body or vehicle armors, synthetic-sapphire bulletproof ballistics, and windows, etc.). Other uses of the solids 21 produced during water splitting in reaction chamber 11 of reactor 10 may be apparent with the help of this disclosure.

The herein disclosed systems and methods for producing hydrogen 6 that can be utilized as an energy source at a wellsite may be particularly useful for hydraulic fracturing applications. Although exemplary applications, such as hydraulic fracturing applications, in which hydrogen is utilized as a fuel source are described herein, other applications may be apparent to one of skill in the art upon reading this disclosure.

This disclosure describes the production of hydrogen 6 and the utilization of all or a portion of the hydrogen 6 as a fuel source at a wellsite. Via this disclosure, hydrogen (H₂) (e.g., all or a portion 6B of the produced hydrogen 6) can be burned (e.g., combusted), and/or hydrogen (e.g., all or a portion 6A of the produced hydrogen 6) can be utilized in one or more fuel cells 30 to produce electricity. In theory, virtually any application that employs an internal combustion engine or generator (reciprocating or turbine) can use an engine utilizing hydrogen 6 as a fuel as described herein. Likewise, any oilfield application that utilizes electricity can be adapted, as described herein, to utilize electricity 31 produced from a hydrogen fuel cell(s) 30. In embodiments, as described herein, 112 can be combined e.g., blended) with existing fuel (e.g., natural gas) infrastructure to reduce logistics and transportation/delivery of traditional mobile fuels.

As per this disclosure, a fuel source for a piece of oilfield equipment 40 can comprise hydrogen in whole or in part. That is, hydrogen can be the sole fuel in the fuel source, or can be used in combination with one or more additional fuel components, for example in a bi-fuel comprising hydrogen and one other fuel component, or in a tri-fuel comprising hydrogen and two other fuel components. Accordingly, reference to the use of H₂ as a fuel can indicate the use of hydrogen, in whole or in part, as fuel.

In embodiments, the hydrogen 6 can be utilized, in whole or in part, to power oilfield equipment 40, for example as described in U.S. patent application Ser. No. 17/948,727 entitled, “Oilfield Applications Using Hydrogen Power”, filed Sep. 20, 2022, the disclosure of which is hereby incorporated herein for purposes not contrary to this disclosure.

Via this disclosure, the hydrogen 6, or a portion thereof, can be utilized, for example, at a wellsite by utilizing mechanical energy or electricity produced at least in part from hydrogen 6 in a fuel comprising hydrogen. Utilizing mechanical energy or electricity produced at least in part from the hydrogen in the fuel comprising hydrogen can comprise electrochemically converting the hydrogen in the fuel comprising hydrogen, or combusting the hydrogen in the fuel comprising hydrogen. For example, utilizing mechanical energy or electricity produced at least in part from the hydrogen in the fuel comprising hydrogen can comprise: (a) converting the hydrogen 6 or a portion 6A thereof to electricity 31 in one or more fuel cells 30 and utilizing the electricity 31 to operate the oilfield equipment 40; (b) combusting the hydrogen 6 or a portion 6B thereof in a power generation apparatus to produce electricity 31 and utilizing the electricity 31 to operate the oilfield equipment 40; and/or (c) combusting the hydrogen 6 or a portion 6B thereof to produce mechanical energy, and utilizing the mechanical energy to operate the oilfield equipment 40.

Hydrogen 6 can be utilized to produce mechanical energy or electricity 31 for powering the oilfield equipment 40. In applications, the oilfield equipment 40 is electric-driven (e.g., comprises an electric motor), in which applications the hydrogen can be utilized in the one or more fuel cells 30 for producing electricity 31 for powering the oilfield equipment 40. Alternatively, a power (e.g., electricity) generation system can be utilized to produce electricity 31 for an electric motor. In embodiments, the hydrogen 6 is utilized in hydrogen combustion apparatus configured to power oilfield equipment 40 via mechanical energy. For example, the oilfield equipment can comprise an engine, such as an internal combustion engine or a reciprocating engine.

In embodiments hydrogen 6 is combusted to produce electricity 31 and the electricity 31 is utilized to operate the oilfield equipment 40. In embodiments, hydrogen 6 is combusted to produce mechanical energy, and the mechanical energy is utilized to operate the oilfield equipment 40. In embodiments, nitrogen oxides (NOx) are removed from an exhaust (e.g., an exhaust gas comprising NOx) produced by the combusting of the hydrogen 6 in the oilfield equipment 40 for producing mechanical apparatus or electricity. In applications, combusting of the hydrogen 6 can be effected in a turbine generator and/or a reciprocating engine generator. In such applications, apparatus for producing mechanical energy or electricity from the hydrogen 6 can comprise a generator, such as a turbine generator or a reciprocating engine generator.

Hydrogen 6 can be produced, stored, and utilized at a single location, or at disparate locations. For example, hydrogen 6 can be produced at a central location, stored at the central location or a second location, and utilized to power oilfield equipment 40 at the central location, at the second location, or at another or third location.

The oilfield equipment can be powered by combustion of a fuel comprising hydrogen 6, a dual fuel comprising the hydrogen 6 and another fuel (e.g., second fuel component), or a tri-fuel comprising the hydrogen 6 and two other fuels (e.g., second fuel component and third fuel component). In embodiments, second fuel component comprises methane or diesel, or comprises methane and a third fuel component comprising diesel. In embodiments, hydrogen 6 can be utilized to at least partially replace a conventional fuel, such as methane or diesel.

Combusting hydrogen 6 in air to power oilfield equipment 40 can produce high levels of nitrogen oxides (NOx), thus combusting hydrogen 6 in air can be utilized, in embodiments, along with the use of apparatus, such as catalytic converters or other apparatus, to reduce the NOx to acceptable levels. Combusting hydrogen 6 in pure oxygen produces only water and heat as byproducts. The utilization of fuel cells 30 to produce electricity 31 from hydrogen 6, as described in embodiments herein, can be particularly useful, as the use of the hydrogen 6 in fuel cells 30 to produce electricity 31 yields no NOx, thus obviating the need for NOx removal apparatus.

Combusting hydrogen 6 in a dual or tri-fuel scenario (e.g., combusting hydrogen 6 in a fuel comprising one other fuel component (e.g., in a dual fuel) or two other fuel components (e.g., in a tri-fuel) can produce more NOx emissions than combusting a fuel comprising hydrogen 6 as the sole fuel source. For example, combusting hydrogen 6 along with methane can produce up to six times the NOx as combusting methane alone. Accordingly, in embodiments, the fuel source utilized to power oilfield equipment 40 consists essentially of hydrogen 6, while, in other embodiments, the fuel source comprises a bi-fuel or a tri-fuel, and NOx removal apparatus can be utilized to remove NOx produced during combustion of the fuel.

As noted hereinabove, the system and method of this disclosure can be utilized to provide hydrogen 6 for use in a wide range of wellbore servicing operations. For example, in embodiments, the operation is selected from hydraulic fracturing operations, pump down operations, coiled tubing operations, wireline operations, nitrogen operations, ancillary support operations, production operations, transporting (e.g., trucking) operations, power generation operations, acidizing operations, drilling operations, pipeline servicing operations, pumping (e.g., pressure pumping), blending (e.g., mixing components of a treatment fluid, such as a fracturing fluid), or combinations thereof.

In embodiments, a method of performing an operation at a wellsite comprises utilizing hydrogen 6 as a fuel source for producing mechanical energy or electricity for powering oilfield equipment 40, wherein the oilfield equipment 40 is utilized in performing an operation at the wellsite 101. As noted previously, by way of example, the operation can be selected from hydraulic fracturing operations, pump down operations, coiled tubing operations, wireline operations, nitrogen operations, ancillary support operations, production operations, transporting (e.g., trucking) operations, power generation operations, acidizing operations, drilling operations, pipeline servicing operations, or combinations thereof. The oilfield equipment 40 can be electric-driven (e.g., can comprise an electric motor). Alternatively or additionally, one or more fuel cells 30 can be utilized for producing electricity 31 via electrochemical conversion of the chemical energy in the hydrogen 6 with an oxidant/oxidizing agent (e.g., air, oxygen, substantially pure oxygen) into electricity 31 via paired redox reactions.

In embodiments, oilfield equipment 40 comprises combustion apparatus operable to combust the fuel comprising hydrogen 6. In embodiments, hydrogen 6 is combusted in an internal combustion engine to produce mechanical energy or electricity for powering the oilfield equipment 40.

In embodiments, the operation comprises a hydraulic fracturing operation. In such embodiments, the oilfield equipment 40 can comprise a hydraulic fracturing equipment. For example, the oilfield equipment 40 can comprise a blender, a proppant system, and a pump, or a combination thereof. The blender can be configured for producing hydraulic fracturing fluid. In embodiments, the hydraulic fracturing fluid comprises mix water, proppant, and/or one or more additional components. In embodiments, the mix water comprises water produced as a byproduct of producing mechanical energy or electricity 31 from the hydrogen 6. For example, the mix water can comprise substantially pure water produced in one or more fuel cells 30 that produce electricity 31 for powering one or more oilfield equipment of the hydraulic fracturing system. A hydraulic fracturing system can include a proppant system configured for providing proppant. For example, in such embodiments, the oilfield equipment 40 can comprise a pump configured to pump fracturing fluid into a formation to produce fractures. The fracturing fluid can be pumped downhole via tubing in a wellbore. A hydraulic fracturing system can further include apparatus selected from forklifts, cranes, centrifugal pumps, sand-handling equipment, or a combination thereof, powered via hydrogen 6 (or electricity 31 produced therefrom). Via this disclosure, oilfield equipment 40 can comprise one or more components of a hydraulic fracturing system (e.g., a blender, one or more components of a proppant system, such as a forklift, crane, sand-handling equipment, etc.), one or more pumps (e.g., downhole pumps, centrifugal pumps) powered by mechanical energy or electricity 31 produced from the hydrogen 6.

In embodiments, as noted above, the oilfield equipment 40 can be powered by an electric motor, a power generation system that produces electricity for the electric motor can utilize hydrogen 6. In embodiments, the oilfield equipment 40 can be powered, and thus comprise, an internal combustion engine operable to combust a fuel comprising hydrogen 6.

In embodiments, the mechanical energy or electricity 31 utilized to power the oilfield equipment 40 can be produced without the production of substantial nitrogen or nitrogen oxides (NOx). For example, the oilfield equipment 40 can be operated with electricity 31 produced via one or more fuel cells 31. In such embodiments. NOx removal apparatus may not be utilized.

In embodiments, oilfield equipment 40 is a component of an electric hydraulic fracturing system, hydrogen 6 is utilized to produce electricity 31 for an electrical grid of the electric hydraulic fracturing system. The electricity can be produced via combustion of hydrogen 6 or electrochemical conversion of the hydrogen 6 to electricity 31 (e.g., in one or more fuel cells 30).

In embodiments, the operation comprises a pump down operation, and oilfield equipment 40 comprises a pump down operations apparatus. Such pump down operations apparatus can be, for example and without limitation, selected from pumping units and centrifugal pumps utilized to pump down wireline perforating guns. In embodiments, the pump down operations apparatus comprises an electric-driven pumping unit employed to pump down wireline perforating guns. In embodiments, electricity 31 produced at least in part from the hydrogen 6 in is utilized to power the electric-driven pumping unit.

In embodiments, the operation comprises a coiled tubing operation and the oilfield equipment 40 comprises a coiled tubing operations apparatus. By way of non-limiting examples, such coiled tubing operations apparatus can be selected from hydraulic power packs used on coiled tubing units, cranes, and other support equipment. In embodiments, the coiled tubing apparatus comprises an electric-coiled tubing apparatus selected from electric-driven hydraulic power packs used on coiled tubing units, cranes, and other support equipment, and electricity 31 produced at least in part from the hydrogen 6 can be utilized to power the coiled tubing operations apparatus.

In embodiments, the operation comprises a wireline operations apparatus and the oilfield equipment 40 comprises a wireline operations apparatus. By way of non-limiting examples, such wireline operations apparatus can be selected from wireline hydraulic power packs, winches, cranes, and other systems. In embodiments, the wireline operations apparatus is selected from electric-driven winches, power packs, cranes, and other systems, and the method comprises utilizing electricity 31 produced at least in part from the hydrogen 6 to power the wireline operations apparatus.

In embodiments, the operation comprises a nitrogen operation and the oilfield equipment 40 comprises a nitrogen operations apparatus. By way of non-limiting examples, such nitrogen operations apparatus can be selected from pumping units and evaporators. In embodiments, the nitrogen operations apparatus is selected from electric-driven nitrogen pumping units and evaporators, and the method comprises utilizing electricity 31 produced at least in part from the hydrogen 6 to power the nitrogen operations apparatus.

In embodiments, the operation comprises an ancillary support operation, and the oilfield equipment 40 comprises an ancillary support operations apparatus. By way of non-limiting examples, such ancillary support operations apparatus can be selected from engines on rig heaters, light plants, water transfer operation apparatus, tele-handlers, and apparatus for carrying out other support functions. In embodiments, the ancillary support operations apparatus is selected from electric-driven heaters, light stands, electric water transfer pumps, electric tele-handlers, and apparatus for carrying out another support function, and the method comprises utilizing electricity 31 produced at least in part from the hydrogen 6 to power the ancillary support operations apparatus.

In embodiments, the operation comprises a production operation and the oilfield equipment 40 comprises a production operations apparatus. By way of non-limiting examples, such production operations apparatus can be selected from pumps, such as, without limitation, fluid injection pumps, gas compression pumps, etc. In embodiments, the production operations apparatus 130 is selected from electric-driven pumps for fluid injection in disposal wells, pressure-maintenance wells, EOR applications, and/or for operating pump jacks, and the method comprises utilizing electricity 31 produced at least in part from the hydrogen 6 to power the production operations apparatus.

In embodiments, the operation comprises a trucking/transport operation and the oilfield equipment 40 comprises a trucking/transport operations apparatus. By way of non-limiting examples, such trucking/transport operations apparatus can be selected from vehicles utilized on the wellsite, such as, without limitation, 18-wheelers, etc. In embodiments, the trucking/transport operations apparatus is selected from electric-driven vehicles, and the method comprises utilizing electricity 31 produced at least in part from the hydrogen 6 to power the trucking/transport operations apparatus.

In embodiments, the operation comprises a power generation operation and the oilfield equipment 40 comprises a power generation operation apparatus, such as, without limitation, an engine on a genset providing electricity 31 (e.g., on the wellsite). As utilized herein a genset is an engine generator comprising an electrical generator and an engine mounted together (e.g., to form a single piece of equipment). A genset is also referred herein as an engine-generator or a “genset”, or simply a generator. In embodiments, the power generation apparatus comprises a fuel cell(s) 30 providing electricity on the wellsite, and the method comprises utilizing the electricity 31 produced at least in part from the hydrogen 6 on the wellsite.

In embodiments, the operation comprises an acidizing operation and the oilfield equipment 40 comprises an acidizing operations apparatus. By way of non-limiting examples, such acidizing operations apparatus can be selected from pumping units and blenders. In embodiments, the acidizing operations apparatus is selected from electric-driven pumping units and blenders, and the method comprises utilizing electricity 31 produced at least in part from the hydrogen 6 to power the acidizing operations apparatus.

In embodiments, the operation comprises a drilling operation and the oilfield equipment 40 comprises a drilling operations apparatus. By way of non-limiting examples, such drilling operations apparatus can be selected from draw works, rotary table drives, top drives, automated tubing handlers, mud pumps, shale shakers, etc. In embodiments, the drilling operations apparatus comprises an electric-driven apparatus, such as electric-driven draw works, rotary table drives, top drives, automated tubing handlers, mud pumps, shale shakers, etc., and the method comprises utilizing electricity 31 produced at least in part from the hydrogen 6 to power the drilling operations apparatus.

In embodiments, the operation comprises a pipeline services operation and the oilfield equipment 40 comprises a pipeline services apparatus. By way of non-limiting examples, such pipeline services apparatus can be selected from mixing systems, single- and multistage-centrifugal pumps, positive displacement pumps, separation equipment, etc. In embodiments, the pipeline services apparatus comprises an electric-driven pipeline services operation apparatus, such as electric-driven inspection equipment, mixing systems, single- and multistage-centrifugal pumps, positive displacement pumps, separation equipment, etc., and the method comprises utilizing electricity 31 produced at least in part from the hydrogen 6 to power the pipeline services operation apparatus.

The system and method disclosed herein may be employed in the context of various wellbore servicing systems and methodologies.

A benefit of utilizing hydrogen as a fuel as described herein can be that such utilization can results in a near zero carbon-product gas emissions from the oilfield equipment 40. Hydrogen 6 of this disclosure can be sourced from renewable power, otherwise known as “green H₂”, or other net negative carbon based energy conversions, such that the production, distribution, and transportation of the hydrogen 6 does not produce undesirable carbon product gas emissions. Accordingly, the system and method can be utilized to enable green H₂ to source the hydrogen 6.

The herein disclosed system and method provide for utilization of numerous sources of water in a catalytic reaction with aluminum 2 by using a low cost catalyst 3 (e.g., a metal hydroxide or metal oxide as a catalyst) to split water to produce hydrogen 6 and produce byproduct aluminum oxide solids 21.

By enabling utilization of a variety of widely available sources of aluminum 2, the cost of the aluminum 2 can be kept low. For example, suitable sources of aluminum 2 include, but are not limited to, aluminum flakes from beverage cans and food packages, aluminum chips, shavings and sawdust found in machine shop waste, and aluminum powder available commercially including fireworks, or other small aluminum particles. Other sources may be apparent with the help of this disclosure.

In embodiments, the reaction chamber 11 can be automated by bridging sensors S and control valve systems for monitoring and providing substantially continuous production of hydrogen gas 6, maintaining a design temperature in the reaction chamber 11, maintaining a substantially constant (e.g., metal hydroxide) catalyst concentration in the reaction chamber 11, feeding additional aluminum 2 and/or additional water 1 to the reaction chamber 11 according to the rates of consumptions of aluminum 2 and water 1 in the reaction chamber 11, and/or removing precipitated byproduct aluminum oxide/hydroxide solids 21 from the reaction chamber 11.

In embodiments, the herein disclosed system and method can be utilized to provide a substantially constant source of hydrogen 6 to directly feed as fuel to power oilfield equipment 40 and/or to feed hydrogen fuel cells 30 for generating electricity 31 at a wellsite to power oilfield equipment 40.

The catalyst can be recycled for the production of additional hydrogen 6 via water splitting. For example, in embodiments employing a liquid metal (e.g., gallium) catalyst 3, the liquid metal obtained from filtration and separation in separation apparatus 20 after water splitting catalytic reaction in reaction chamber 11 maintains its efficiency and can be recycled (e.g., via recycle line 23 of system I of FIG. 1 and/or via a recycled metal hydroxide solution in recycle line 22 in system II of FIG. 2) to form catalyst composition with additional aluminum particulates 2 and water 1 for subsequent use during hydrogen 6 generation reactions in reaction chamber 11. Accordingly, in embodiments, the catalyst 3 (e.g., gallium) can be recovered and recycled for further use in generating hydrogen 6 (e.g., via the production of additional aluminum-liquid metal catalyst) substantially indefinitely.

In embodiments, the system and method of this disclosure provide for producing hydrogen 6 while operating at ambient temperature and atmospheric pressure, and without requiring high temperature and/or pressure that are often required to enhance hydrogen production efficiency in other hydrogen generation processes. Via the system and method of this disclosure, the hydrogen generating water splitting reaction can be performed at room temperature, under atmospheric pressure, neutral pH, and/or without requiring catalytic electrodes or electrical potential. For example, the use of liquid metal catalysts 3 that have a low melting point (e.g., from about 20° C. to about 40° C. from about 25° C. to about 40° C., or from about 25° C. to about 30° C.) can enable the catalyst 3 to act as a room temperature liquid metal catalyst 3. Because the disclosed system and method provide for water splitting at room or otherwise low temperature range can enable the process to be economically viable due to the savings obtained by not paying for the energy to provide for conventionally-required high temperatures.

In embodiments, the system and method of this disclosure provide for the utilization of a processed low-TDS water 1 obtained via water treatment (e.g., in water treatment apparatus 5) of produced (e.g., high-TDS) water 5′ produced from wells (e.g., oil and/or gas wells) to generate hydrogen 6 via catalytic water splitting to power oilfield equipment 40 (e.g., hydraulic fracturing oilfield equipment 40).

In embodiments, the system and method provide for sequestering CO₂ that has been captured from the exhaust gas 26 produced, for example, by fracturing operations at well sites, or from other emission sources, such as power plants, cement plants, etc.

In embodiments, a high-TDS water 5′, such as produced water, can be treated (e.g., “desalinated”) to produce low-TDS, freshwater that can be applied for multiple purposes, including as described in this disclosure, as a source of water 1 for use in water-splitting catalytic reaction for producing hydrogen 6 for use as fuel to power oilfield equipment 40 and/or as a fuel source of H₂-fuel cells 30 to generate electricity 31 to power oilfield equipment 40 (e.g., fracturing equipment).

Other advantages will be apparent to those of skill in the art and with the help of this disclosure.

### ADDITIONAL DISCLOSURE

The following are non-limiting, specific embodiments in accordance with the present disclosure:

In a first embodiment, a system comprises: a reactor configured for catalytic water splitting to produce hydrogen and byproduct solids via contact of water and aluminum in the presence of a catalyst comprising a metal, a metal hydroxide, a metal oxide, or a combination thereof, wherein the reactor comprises one or more inlets whereby water, aluminum, the catalyst, or a combination thereof are introduced to a reaction chamber of the reactor, an outlet for hydrogen, and an outlet for a slurry comprising water, catalyst, and solids comprising aluminum oxide, aluminum hydroxide, or a combination thereof; a solid/liquid separation apparatus configured to separate the solids from the slurry to provide a solids-reduced slurry; and oilfield equipment, wherein the oilfield equipment is operable via the hydrogen as fuel and/or via electricity produced from the hydrogen.

A second embodiment can include the system of the first embodiment further comprising a recycle line fluidly connecting the solid/liquid separation apparatus with the reactor, whereby at least a portion of the solids-reduced solution can be recycled to the reactor.

A third embodiment can include the system of the second embodiment, wherein the solid/liquid separation apparatus is further configured to separate catalyst from the slurry.

A fourth embodiment can include the system of the third embodiment further comprising a recycle line fluidly connecting the solid/liquid separation apparatus with the reactor and configured for recycle of separated catalyst from the solid/liquid separation apparatus to the reactor.

A fifth embodiment can include the system of the fourth embodiment, wherein the catalyst comprises a liquid metal selected from gallium, indium, tin, or a combination thereof.

A sixth embodiment can include the system of any one of the first to fifth embodiments further comprising a water treatment apparatus operable to produce a low-total dissolved solids (TDS) water from a high-TDS water, wherein the low-TDS water comprises a lower amount of total dissolved solids than the high-TDS water.

A seventh embodiment can include the system of the sixth embodiment, wherein the high-TDS water comprises produced water.

An eighth embodiment can include the system of the seventh embodiment, wherein the produced water is produced on-site at a same location as the oilfield equipment and/or the reactor.

A ninth embodiment can include the system of any one of the sixth to eighth embodiments, wherein the water treatment apparatus comprises apparatus configured for contacting the high-TDS water with carbon dioxide (CO₂) to produce one or more metal carbonates and separate a precipitant comprising the one or more metal carbonates from the low-TDS water, apparatus configured for heating the high-TDS water to produce the low-TDS water via evaporation and/or distillation, or a combination thereof.

A tenth embodiment can include the system of the ninth embodiment, wherein the CO₂ is produced by the oilfield apparatus and/or is produced at a same location as that of the oilfield apparatus.

An eleventh embodiment can include the system of any one of the ninth or the tenth embodiment, wherein the CO₂ is a component of an exhaust gas produced by fracturing operations on-site at a same location as the oilfield equipment and/or the reactor, an exhaust gas produced via a power plant, an exhaust gas produced from a cement plant, or a combination thereof.

A twelfth embodiment can include the system of any one of the first to eleventh embodiments, wherein the catalyst comprises metal oxide and/or metal hydroxide and wherein the solids-reduced slurry comprises an aqueous metal hydroxide and/or metal oxide solution and wherein the solids comprise aluminum oxide (Al₂O₃).

A thirteenth embodiment can include the system of any one of the first to twelfth embodiments further comprising one or a plurality of hydrogen fuel cells operable to produce electricity and byproduct water from the hydrogen.

A fourteenth embodiment can include the system of the thirteenth embodiment further comprising a water recycle line fluidly connecting the one or the plurality of fuel cells with the reactor whereby water produced via the one or the plurality of the fuel cells can be introduced into the reactor.

A fifteenth embodiment can include the system of any one of the first to fourteenth embodiments further comprising a hydrogen storage apparatus configured to store at least a portion of the hydrogen or the energy thereof.

A sixteenth embodiment can include the system of the fifteenth embodiment, wherein the hydrogen storage apparatus stores the at least the portion of the hydrogen as magnesium hydride or via conversion of the at least the portion of the hydrogen to electricity in a fuel cell and storage of the electricity in one or more charged batteries.

A seventeenth embodiment can include the system of any one of the first to sixteenth embodiments, wherein the oilfield equipment comprises hydraulic fracturing equipment.

An eighteenth embodiment can include the system of any one of the first to seventeenth embodiments, wherein the catalyst comprises a liquid metal selected from gallium, indium, tin, or a combination thereof.

A nineteenth embodiment can include the system of any one of the first to eighteenth embodiments, wherein the catalyst comprises a liquid metal, wherein the liquid metal has a melting point in a range of from about 20 to about 40° C. from about 25 to about 40° C., or from about 25 to about 35° C.

A twentieth embodiment can include the system of any one of the first to nineteenth embodiments, wherein the reactor is configured for water splitting at room temperature, atmospheric pressure, neutral pH1, without the use of catalytic electrodes, electric potential, or a combination thereof.

A twenty first embodiment can include the system of any one of the first to twentieth embodiments, wherein the aluminum comprises aluminum particulates.

A twenty second embodiment can include the system of the twenty first embodiment, wherein the aluminum particulates comprise flakes, sawdust, milling shavings, chips, powder, or a combination thereof.

A twenty third embodiment can include the system of any one of the first to twenty second embodiments, wherein the aluminum comprises new aluminum foil or a recycled aluminum selected from aluminum foil, food wrapping, beverage cans, baking trays, machine shop waste (e.g., aluminum chips, shavings, and/or sawdust), fireworks, aluminum powder, or a combination thereof.

A twenty fourth embodiment can include the system of any one of the first to twenty third embodiments, wherein the reactor comprises an agitator selected from sonicators, vibrators, homogenizers, stirrers, blenders, and combinations thereof.

A twenty fifth embodiment can include the system of any one of the first to twenty fourth embodiments, wherein the reactor, the solid/liquid separation apparatus, or both are located at a central location and the oilfield apparatus is located at the central location or another location, and/or wherein the reactor, the solid/liquid separation apparatus, or both are positioned on a trailer or skid configured for positioning at a location at which the oilfield equipment is located.

A twenty sixth embodiment can include the system of any one of the first to twenty sixth embodiments, wherein the reactor is configured for: (a) monitoring and substantially constant production of hydrogen gas, (b) maintaining a design temperature in the reactor, (c) maintaining a substantially constant catalyst by feeding additional aluminum and water according to rates of consumption of aluminum and water in the reaction chamber, and/or (d) removing the precipitated byproduct solids from the reaction chamber.

A twenty seventh embodiment can include the system of any one of the first to twenty seventh embodiments, wherein the catalyst comprises a metal hydroxide selected from sodium hydroxide, potassium hydroxide, calcium hydroxide, magnesium hydroxide, or a combination thereof; a metal oxide selected from sodium oxide, potassium oxide, calcium oxide, and combinations thereof; or a combination thereof.

A twenty eighth embodiment can include the system of any one of the first to twenty eighth embodiments, wherein the solids comprise Al₂O₃, Al(OH)₃, or a combination thereof.

A twenty ninth embodiment can include the system of any one of the first to twenty eighth embodiments, wherein an inner wall of the reaction chamber is designed to prevent or minimize corrosion thereof.

A thirtieth embodiment can include the system of any one of the first to twenty ninth embodiments, wherein the reaction chamber is equipped with one or more temperature sensors, chemical sensors, acoustic sensors, optic sensors, or a combination thereof to provide automation of control valves for maintaining the addition of aluminum and water to the reactor and removal of byproduct solids from the reactor.

A thirty first embodiment can include the system of any one of the first to thirtieth embodiments, wherein the reactor further comprises a heat exchanger configured for the removal of heat from the reaction chamber.

A thirty second embodiment can include the system of the thirty second embodiment, further comprising a water treatment apparatus operable to produce a low-total dissolved solids (TDS) water from a high-TDS water, wherein the low-TDS water comprises a lower amount of total dissolved solids than the high-TDS water, wherein the water treatment apparatus is configured for heating the high-TDS water to produce the low-TDS water via evaporation and/or distillation, and wherein the heat exchanger is fluidly connected with the water treatment apparatus such that heat removed from the reaction chamber can be utilized in the water treatment apparatus.

A thirty third embodiment can include the system of any one of the first to thirty second embodiments, wherein the reactor further comprises a screen positioned below a liquid level in the reaction chamber and configured to allow the byproduct precipitant solids to pass therethrough, thus separating the solids from the liquids in the reaction chamber and preventing mixing and interference of the solids with the catalytic water splitting reaction of the water and the aluminum in the reaction chamber.

A thirty fourth embodiment can include the system of any one of the first to thirty third embodiments, wherein a bottom portion of the reaction chamber is conical in shape, thus facilitating the accumulation of byproduct precipitant solids in the bottom portion of the reaction chamber.

In a thirty fifth embodiment, a method comprises producing hydrogen and a slurry comprising water, unreacted catalyst, and byproduct solids by catalytic water splitting via contact of water and aluminum in the presence of a catalyst comprising a metal, a metal hydroxide, a metal oxide, or a combination thereof; separating the byproduct solids from the slurry to provide a solids-reduced slurry; and operating oilfield equipment via the hydrogen as fuel and/or via electricity produced from the hydrogen.

A thirty sixth embodiment can include the method of the thirty fifth embodiment further comprising recycling at least a portion of the solids-reduced solution to the reactor.

A thirty seventh embodiment can include the method of the thirty sixth embodiment further comprising separating the catalyst from the slurry.

A thirty eighth embodiment can include the method of the thirty seventh embodiment further comprising recycling separated catalyst to the reactor.

A thirty ninth embodiment can include the method of the thirty eighth embodiment, wherein the catalyst comprises a liquid metal selected from gallium, indium, tin, or a combination thereof.

A fortieth embodiment can include the method of any one of the thirty fifth to thirty ninth embodiments further comprising producing a low-total dissolved solids (TDS) water from a high-TDS water, wherein the low-TDS water comprises a lower amount of total dissolved solids than the high-TDS water, and utilizing the low-TDS water to produce the slurry.

A forty first embodiment can include the method of the fortieth embodiment, wherein the high-TDS water comprises produced water from an oil or gas well.

A forty second embodiment can include the method of any one of the fortieth or forty first embodiments, wherein producing the low-TDS water comprises contacting the high-TDS water with carbon dioxide (CO₂) to produce one or more metal carbonates and separating a precipitant comprising the one or more metal carbonates from the low-TDS water; heating the high-TDS water to produce the low-TDS water via evaporation and/or distillation; or a combination thereof.

A forty third embodiment can include the method of the forty second embodiment, wherein the CO₂ is produced by the oilfield apparatus and/or is produced at a same location as that of the oilfield apparatus.

A forty fourth embodiment can include the method of the forty third embodiment, wherein the CO₂ is a component of an exhaust gas produced by hydraulic fracturing operations on-site at a same location as the oilfield equipment and/or the reactor or another location, wherein the CO₂ is a component of an exhaust gas produced via a power plant, wherein the CO₂ is a component of an exhaust gas produced from a cement plant, or a combination thereof.

A forty fifth embodiment can include the method of any one of the fortieth to forty fourth embodiments, wherein the high-TDS water comprises produced water, and further comprising producing the produced water on-site at a same location as the oilfield equipment and/or the reactor.

A forty sixth embodiment can include the method of any one of the thirty fifth to forty fifth embodiments, wherein the catalyst comprises metal oxide and/or metal hydroxide and wherein the solids-reduced slurry comprises an aqueous metal hydroxide and/or metal oxide solution and wherein the byproduct solids comprise aluminum oxide (Al₂O₃).

A forty seventh embodiment can include the method of any one of the thirty fifth to forty sixth embodiments further comprising utilizing the hydrogen to produce electricity and byproduct water via one or a plurality of hydrogen fuel cells.

A forty eighth embodiment can include the method of the forty seventh embodiment further comprising utilizing at least a portion of the byproduct water from the hydrogen fuel cells in the slurry.

A forty ninth embodiment can include the method of any one of the thirty fifth to forty eighth embodiments further comprising storing at least a portion of the hydrogen or an energy thereof.

A fiftieth embodiment can include the method of the forty ninth embodiment, wherein storing the at least the portion of the hydrogen comprises storing the at least the portion of the hydrogen as magnesium hydride or via conversion of the at least the portion of the hydrogen to electricity and storage of the electricity in one or more charged batteries.

A fifty first embodiment can include the method of any one of the thirty fifth to fiftieth embodiments, wherein the oilfield equipment comprises hydraulic fracturing equipment.

A fifty second embodiment can include the method of any one of the thirty fifth to forty first embodiments, wherein the catalyst comprises a liquid metal.

A fifty third embodiment can include the method of the fifty second embodiment, wherein the liquid metal has a melting point in a range of from about 20 to about 40° C., from about 25 to about 40° C., or from about 25 to about 35° C.

A fifty fourth embodiment can include the method of any one of the thirty fifth to fifty third embodiments, wherein the catalytic water splitting is effected at room temperature, atmospheric pressure, neutral pH, without the use of catalytic electrodes, electric potential, or a combination thereof.

A fifty fifth embodiment can include the method of any one of the thirty fifth to fifty fourth embodiments, wherein the catalyst comprises a liquid metal selected from gallium, indium, tin, or a combination thereof.

A fifty sixth embodiment can include the method of any one of the thirty fifth to fifty fifth embodiments, wherein the aluminum comprises aluminum particulates.

A fifty seventh embodiment can include the method of the fifty sixth embodiment, wherein the aluminum particulates comprise flakes, sawdust, milling shavings, chips, powder, or a combination thereof.

A fifty eighth embodiment can include the method of any one of the thirty fifth to fifty seventh embodiments, wherein the aluminum comprises new aluminum foil or a recycled aluminum selected from aluminum foil, food wrapping, beverage cans, baking trays, machine shop waste (e.g., aluminum chips, shavings, and/or sawdust), fireworks, aluminum powder, or a combination thereof.

A fifty ninth embodiment can include the method of any one of the thirty fifth to fifty eighth embodiments further comprising agitating a mixture of the water, the aluminum, and the catalyst via sonication, vibration, homogenization, stirring, blending, or a combination thereof.

A sixtieth embodiment can include the method of any one of the thirty fifth to fifty ninth embodiments further comprising producing the hydrogen at a central location and operating the oilfield apparatus at the central location or another location.

A sixty first embodiment can include the method of any one of the thirty fifth to sixtieth embodiments further comprising: (a) monitoring and substantially constantly producing the hydrogen gas. (b) maintaining a design temperature of the catalytic water splitting, (c) maintaining a substantially constant catalyst concentration during the catalytic water splitting by feeding additional aluminum and water according to rates of consumption of aluminum and water via the catalytic water splitting, and/or (d) removing the precipitated byproduct solids produced via the catalytic water splitting.

A sixty second embodiment can include the method of any one of the thirty fifth to sixty first embodiments, wherein the catalyst comprises a metal hydroxide selected from sodium hydroxide, potassium hydroxide, calcium hydroxide, magnesium hydroxide, or a combination thereof; a metal oxide selected from sodium oxide, potassium oxide, calcium oxide, and combinations thereof; or a combination thereof.

A sixty third embodiment can include the method of any one of the thirty fifth to sixty second embodiments, wherein the byproduct solids comprise Al₂O₃, Al(OH)₃, or a combination thereof.

A sixty fourth embodiment can include the method of any one of the thirty fifth to sixty third embodiments further comprising maintaining an addition of aluminum and water to the catalytic water splitting and removal of byproduct solids from the catalytic water splitting via control valves automated via the use of one or more temperature sensors, chemical sensors, acoustic sensors, optic sensors, or a combination thereof.

A sixty fifth embodiment can include the method of any one of the thirty fifth to sixty fourth embodiments further comprising utilizing at least a portion of the heat produced by the catalytic water splitting.

A sixty sixth embodiment can include the method of the sixty fifth embodiment, wherein utilizing the heat further comprises utilizing the heat to produce a low-total dissolved solids (TDS) water from a high-TDS water by heating the high-TDS water to produce the low-TDS water via evaporation and/or distillation, wherein the low-TDS water comprises a lower amount of total dissolved solids than the high-TDS water.

In a sixty seventh embodiment, a method comprises: producing hydrogen and a slurry comprising water, unreacted catalyst, and byproduct solids by catalytic water splitting via contact of water and aluminum in the presence of a catalyst; and operating oilfield equipment via the hydrogen as fuel and/or via electricity produced from the hydrogen.

A sixty eighth embodiment can include the method of the sixty seventh embodiment, wherein the catalyst comprises a metal (e.g., a liquid metal), a metal hydroxide, a metal oxide, or a combination thereof.

In a sixty ninth embodiment, a system comprises: a reactor configured for catalytic water splitting to produce hydrogen and byproduct solids via contact of water and aluminum in the presence of a catalyst, wherein the reactor comprises one or more inlets whereby water, aluminum, the catalyst, or a combination thereof are introduced to a reaction chamber of the reactor, an outlet for hydrogen, and an outlet for a slurry comprising water, catalyst, and solids comprising aluminum oxide, aluminum hydroxide, or a combination thereof; and oilfield equipment, wherein the oilfield equipment is operable via the hydrogen as fuel and/or via electricity produced from the hydrogen.

A seventieth embodiment can include the system of the sixty ninth embodiment, wherein the catalyst comprising a metal (e.g., a liquid metal), a metal hydroxide, a metal oxide, or a combination thereof.

While embodiments have been shown and described, modifications thereof can be made by one skilled in the art without departing from the spirit and teachings of this disclosure. The embodiments described herein are exemplary only, and are not intended to be limiting. Many variations and modifications of the embodiments disclosed herein are possible and are within the scope of this disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, RI, and an upper limit. Ru, is disclosed, any number falling within the range is specifically disclosed. In particular, the following numbers within the range are specifically disclosed: R=Rl+k*(Ru−Rl), wherein k is a variable ranging from 1 percent to 100 percent with a 1 percent increment. i.e., k is 1 percent, 2 percent, 3 percent, 4 percent, 5 percent, . . . 50 percent, 51 percent, 52 percent, . . . , 95 percent, 96 percent, 97 percent, 98 percent, 99 percent, or 100 percent. Moreover, any numerical range defined by two R numbers as defined in the above is also specifically disclosed. Use of broader terms such as comprises, includes, having, etc. should be understood to provide support for narrower terms such as consisting of, consisting essentially of, comprised substantially of, etc. When a feature is described as “optional,” both embodiments with this feature and embodiments without this feature are disclosed. Similarly, the present disclosure contemplates embodiments where this “optional” feature is required and embodiments where this feature is specifically excluded.

Accordingly, the scope of protection is not limited by the description set out above but is only limited by the claims which follow, that scope including all equivalents of the subject matter of the claims. Each and every claim is incorporated into the specification as embodiments of the present disclosure. Thus, the claims are a further description and are an addition to the embodiments of the present disclosure. The discussion of a reference herein is not an admission that it is prior art, especially any reference that can have a publication date after the priority date of this application. The disclosures of all patents, patent applications, and publications cited herein are hereby incorporated by reference, to the extent that they provide exemplary, procedural, or other details supplementary to those set forth herein.

What is claimed is:

1. A system comprising:
a reactor configured for catalytic water splitting to produce hydrogen and byproduct solids via contact of water and aluminum in the presence of a catalyst comprising a metal, a metal hydroxide, a metal oxide, or a combination thereof, wherein the reactor comprises one or more inlets whereby water, aluminum, the catalyst, or a combination thereof are introduced to a reaction chamber of the reactor, an outlet for hydrogen, and an outlet for a slurry comprising water, catalyst, and solids comprising aluminum oxide, aluminum hydroxide, or a combination thereof;
a solid/liquid separation apparatus configured to separate the solids from the slurry to provide a solids-reduced slurry; and
oilfield equipment, wherein the oilfield equipment is operable via the hydrogen as fuel and/or via electricity produced from the hydrogen.

2. The system of claim 1 further comprising a recycle line fluidly connecting the solid/liquid separation apparatus with the reactor, whereby at least a portion of the solids-reduced solution can be recycled to the reactor.

3. The system of claim 1 further comprising a water treatment apparatus operable to produce a low-total dissolved solids (TDS) water from a high-TDS water, wherein the low-TDS water comprises a lower amount of total dissolved solids than the high-TDS water.

4. The system of claim 1, wherein the catalyst comprises metal oxide and/or metal hydroxide and wherein the solids-reduced slurry comprises an aqueous metal hydroxide and/or metal oxide solution and wherein the solids comprise aluminum oxide (Al₂O₃).

5. The system of claim 1 further comprising one or a plurality of hydrogen fuel cells operable to produce electricity and byproduct water from the hydrogen.

6. The system of claim 1 further comprising a hydrogen storage apparatus configured to store at least a portion of the hydrogen or the energy thereof.

7. The system of claim 1, wherein the oilfield equipment comprises hydraulic fracturing equipment.

8. The system of claim 1, wherein the catalyst comprises a liquid metal selected from gallium, indium, tin, or a combination thereof.

9. The system of claim 1, wherein the catalyst comprises a liquid metal, wherein the liquid metal has a melting point in a range of from about 20 to about 40° C., from about 25 to about 40° C., or from about 25 to about 35° C.

10. The system of claim 1, wherein the catalyst comprises a metal hydroxide selected from sodium hydroxide, potassium hydroxide, calcium hydroxide, magnesium hydroxide, or a combination thereof; a metal oxide selected from sodium oxide, potassium oxide, calcium oxide, and combinations thereof; or a combination thereof.

11. A method comprising:
producing hydrogen and a slurry comprising water, unreacted catalyst, and byproduct solids by catalytic water splitting via contact of water and aluminum in the presence of a catalyst comprising a metal, a metal hydroxide, a metal oxide, or a combination thereof;
separating the byproduct solids from the slurry to provide a solids-reduced slurry; and
operating oilfield equipment via the hydrogen as fuel and/or via electricity produced from the hydrogen.

12. The method of claim 11 further comprising recycling at least a portion of the solids-reduced solution to the reactor.

13. The method of claim 11 further comprising producing a low-total dissolved solids (TDS) water from a high-TDS water, wherein the low-TDS water comprises a lower amount of total dissolved solids than the high-TDS water, and utilizing the low-TDS water to produce the slurry.

14. The method of claim 13, wherein the high-TDS water comprises produced water, and further comprising producing the produced water on-site at a same location as the oilfield equipment and/or the reactor.

15. The method of claim 11, wherein the catalyst comprises metal oxide and/or metal hydroxide and wherein the solids-reduced slurry comprises an aqueous metal hydroxide and/or metal oxide solution and wherein the byproduct solids comprise aluminum oxide (Al₂O₃).

16. The method of claim 11 further comprising utilizing the hydrogen to produce electricity and byproduct water via one or a plurality of hydrogen fuel cells.

17. The method of claim 11, wherein the catalyst comprises a liquid metal.

18. The method of claim 11, wherein the catalyst comprises a liquid metal selected from gallium, indium, tin, or a combination thereof.

19. The method of claim 11, wherein the catalyst comprises a metal hydroxide selected from sodium hydroxide, potassium hydroxide, calcium hydroxide, magnesium hydroxide, or a combination thereof; a metal oxide selected from sodium oxide, potassium oxide, calcium oxide, and combinations thereof; or a combination thereof.

20. A system comprising:
a reactor configured for catalytic water splitting to produce hydrogen and byproduct solids via contact of water and aluminum in the presence of a catalyst comprising a metal, a metal hydroxide, a metal oxide, or a combination thereof, wherein the reactor comprises one or more inlets whereby water, aluminum, the catalyst, or a combination thereof are introduced to a reaction chamber of the reactor, an outlet for hydrogen, and an outlet for a slurry comprising water, catalyst, and solids comprising aluminum oxide, aluminum hydroxide, or a combination thereof; and
oilfield equipment, wherein the oilfield equipment is operable via the hydrogen as fuel and/or via electricity produced from the hydrogen.
